(19) United States
(12) Patent Application Publication
(10) Pub. No.: US 2004/0209050 A1
(43) Pub. Date: Oct. 21, 2004

(54) Method and device for producing a laminated embossed and printed web of flexible material, such as paper and nonwoven, and a laminated web material produced thereby

(75) Inventor: Anders Andersson, Stenungsund (SE)

Correspondence Address: YOUNG & THOMPSON, 745 SOUTH 23RD STREET 2ND FLOOR, ARLINGTON, VA, 22202

(73) Assignee: SCA HYGIENE PRODUCTS AB, GOTEBORG (SE)

(21) Appl. No.: 10/826,295

(22) Filed: Apr. 19, 2004

Related U.S. Application Data
(60) Provisional application No. 60/463,327, filed on Apr. 17, 2003.

(51) Int. Cl. D21F 11/00; B32B 3/00

(52) U.S. Cl. 428/172

(57) ABSTRACT

Method and device for producing a laminated, embossed and printed web of flexible material, such as paper and nonwoven material. Each of two web-shaped materials are separately embossed in selected embossing patterns while leaving other areas substantially non-embossed, at least one of the web-shaped materials is printed in a selected printing pattern, the printing and embossing steps being synchronized so that printing occurs mainly in the non-embossed areas of the web-shaped material. Glue is transferred to the embossed areas of at least one of the web-shaped materials and the embossed areas of the two web-shaped materials are adhesively joined in a lamination step to form a laminated web product.

### CROSS REFERENCE TO RELATED APPLICATION

This application claims the 35 U.S.C. § 119(e) benefit of Provisional U.S. Application 60/463,327 filed on Apr. 17, 2003.

### FIELD OF THE INVENTION

The present invention refers to a method and a device for producing a laminated, embossed and printed web of flexible material, such as paper and nonwoven material. Especially it refers to production of tissue products such as toilet and kitchen paper, paper towels, handkerchiefs, wiping material and the like. The invention further refers to a laminated, embossed and printed web of flexible material, such as paper and nonwoven.

### BACKGROUND OF THE INVENTION

It is common to emboss and print tissue products. Embossing is a way of increasing the bulk of the paper and it also gives a three-dimensional structure to the paper, which improves the absorption properties and also the aesthetic appearance of the tissue product. Embossing may further be a way of laminating two or more tissue paper plies together, at which a mechanical joining of the plies occur in the embossing sites. Embossing is often combined with gluing for laminating tissue paper plies. This is for example disclosed in U.S. Pat. No. 3,414,459, in which laminating of tissue plies by a combined embossing and gluing procedure is shown. The embossing is of so called foot-to-foot type according to which the raised protuberances of the embossed tissue plies are joined together. In U.S. Pat. No. 3,867,225 there is also disclosed a combined embossing and gluing process, but where the embossing is of so called nested type according to which the raised projections of one tissue ply will rest in and be joined to the depressions of the opposite ply.

Printing of tissue paper is often made for aesthetical reasons. The printing pattern could be any pattern including more or less continuous lines, line segments, dots, trademarks, logotypes, symbols, fantasy characters etc. One conventional way of embossing and printing a tissue paper is to perform the embossing first and subsequently the printing. This method will result in that the printing colorant will be located substantially only on the raised projections of the embossing pattern. An example of such method is found in U.S. Pat. No. 5,339,730.

According to an alternative method the printing of one tissue ply is made first and subsequently this tissue ply is embossed and laminated with another tissue ply. A drawback with such a method is that the colorant is not always completely dry before the embossing, which means a risk that the printing will be blurred.

In both these methods there is a risk that the embossing deteriorates the quality of the printing.

The Swedish patent application no. 0103469-3 discloses a method and a device for embossing and printing a web material, for example tissue paper, wherein the printing and embossing steps are synchronized so that printing occurs mainly in non-embossed areas of the web material.

### OBJECT OF THE INVENTION

The object of the present invention is to provide a method for producing a laminated, printed and embossed web of flexible material, such as paper and nonwoven material, of an improved quality. According to one embodiment the invention refers to a laminated tissue product.

### SUMMARY OF THE INVENTION

This object has according to the invention been provided by separately embossing each of two web-shaped materials in selected embossing patterns while leaving other areas substantially non-embossed;

printing at least one of said web-shaped materials in a selected printing pattern, said printing and embossing steps being synchronized so that printing occurs mainly in the non-embossed areas of the web-shaped material;

transferring glue to the embossed areas of at least one of the web-shaped materials and adhesively joining the embossed areas of the two web-shaped materials in a lamination step to form a laminated product.

The webs that undergo the embossing and printing steps can be a one-ply or a multiply material. The multi-ply web can be a laminated web in which the plies have been joined by for example by gluing and/or embossing. The multi-ply web can alternatively comprise two or more plies which have not been joined, and which will be joined together by the embossing and/or gluing steps.

The invention further refers to a device for embossing and printing a web of flexible material, such as paper and nonwoven material, said device comprising a printing roll adapted to carry a colorant in a selected pattern,

a central first embossing roll having a three dimensional pattern of protuberances being interrupted by relatively smooth areas;

a second embossing roll having a three dimensional pattern of protuberances being interrupted by relatively smooth areas;

said printing roll and said second embossing roll are cooperating with and kept in registry with said central first embossing roll.

In addition the invention refers to a laminated, printed and embossed web of flexible material, such as paper and nonwoven, said web comprising at least one web-shaped flexible material which is embossed in selected areas while other areas are non-embossed and which is printed in a selected pattern in said non-embossed areas, said web comprising at least one further web-shaped flexible material, which is embossed in selected areas while other areas are non-embossed, wherein the at least two web-shaped flexible materials are adhesively joined in their respective embossed areas to produce said laminated, printed and embossed web.

The paper web may in one embodiment besides said selected printing pattern be provided with other printing patterns optionally configured on the paper web.

The web of material is according to one embodiment tissue paper, which may be a one-ply or multi-ply tissue product.

Further features of the invention are disclosed in the following description and in the claims.

### BRIEF DESCRIPTION OF THE DRAWINGS

The invention will in the following be closer described with reference to some embodiments shown in the accompanying drawings.

FIG. 1 shows a schematic side view of a device for performing the method according to one embodiment of the invention.

FIG. 2 is a schematic cross-section through a laminated web material produced by the device in FIG. 2.

FIG. 3 is a side view corresponding to FIG. 1 but according to another embodiment.

FIG. 4 is a schematic cross-section through a laminated web material produced by the device in FIG. 3.

FIG. 5 is a side view corresponding to FIGS. 1 and 3 but according to a modified embodiment.

FIG. 6 is a schematic view of a web material according to the invention.

### DETAILED DESCRIPTION OF THE INVENTION

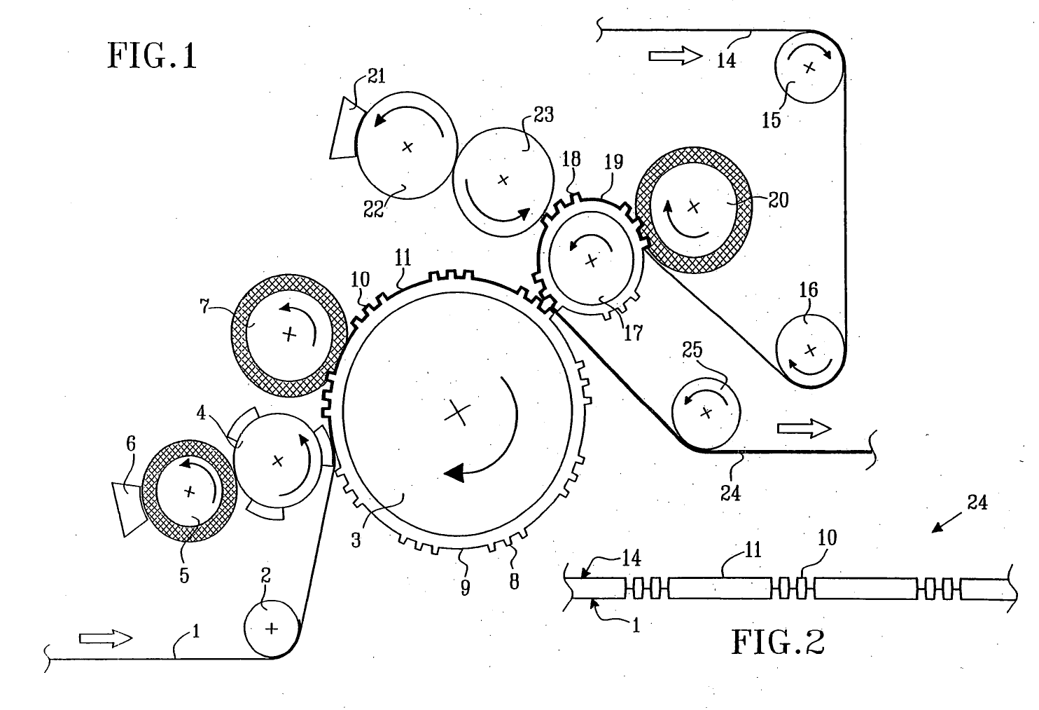

FIG. 1 shows a device for producing a laminated web material, e.g. paper or nonwoven, especially tissue paper. In the following description the web material will be referred to as a paper web. A first paper web 1 is via a guide roll 2 brought into a first nip between a central first embossing roll 3 and a printing roll 4 carrying a colorant in a selected pattern. The paper web 1 can be a one-ply or a multi-ply material. The multi-ply paper web can be a laminated web in which the plies have been joined by for example gluing and/or embossing. The multi-ply paper web can alternatively comprise two or more plies which have not yet been joined.

The printing roll 4 is according to one embodiment a so called block-printing roll. Non-limiting examples of such block-printing rolls are laser-engraved solid or sleeve rubber rolls. Colorant is transferred to the printing roll 4 via an anilox roll 5, which picks up colorant from an enclosed doctor chamber 6 for ink.

The printing pattern 13 has an optional appearance and can be geometrical patterns, figurative patterns, symbols, text, trade names, logotypes etc.

The paper web 1 is subsequently fed into a second nip between the central embossing roll 3 and an impression roll 7. The central embossing roll 3 has a three dimensional pattern of protuberances 8, said three dimensional pattern being interrupted by relatively smooth areas 9. The central impression roll 3 is of a harder material than the impression roll 7, which is of a non-rigid material. The impression roll 7 can be of a resilient rubber material or of a yielding but non-resilient material, for example a cellulosic material, in which permanent impressions will be formed by the central embossing roll 3. The central embossing roll 3 can be of steel or of a rubber material that is harder than the material in the impression roll 7, so that the protuberances 8 on the central embossing roll 3 will cause temporary or permanent impressions in the surface of the impression roll 7.

According to an alternative embodiment (not shown), the impression roll 7 is of a rigid material, for example steel, and has a three-dimensional pattern of alternating raised and recessed portions, said three dimensional pattern being interrupted by relatively smooth areas, wherein the three-dimensional pattern on the impression roll 7 matches with that of the central embossing roll 3. The central embossing roll 3 and impression roll 7 are driven so that the alternating raised and recessed portions patterns thereon will match into each other and the relatively smooth areas will be facing each other.

The term relatively smooth in this respect means that these areas of the pattern roll either lack a three-dimensional pattern of alternating raised and recessed portions or protuberances that will cause a visible embossing pattern in the web, or that these areas have only a slight three-dimensional pattern that is much less pronounced than said three-dimensional pattern of protuberances.

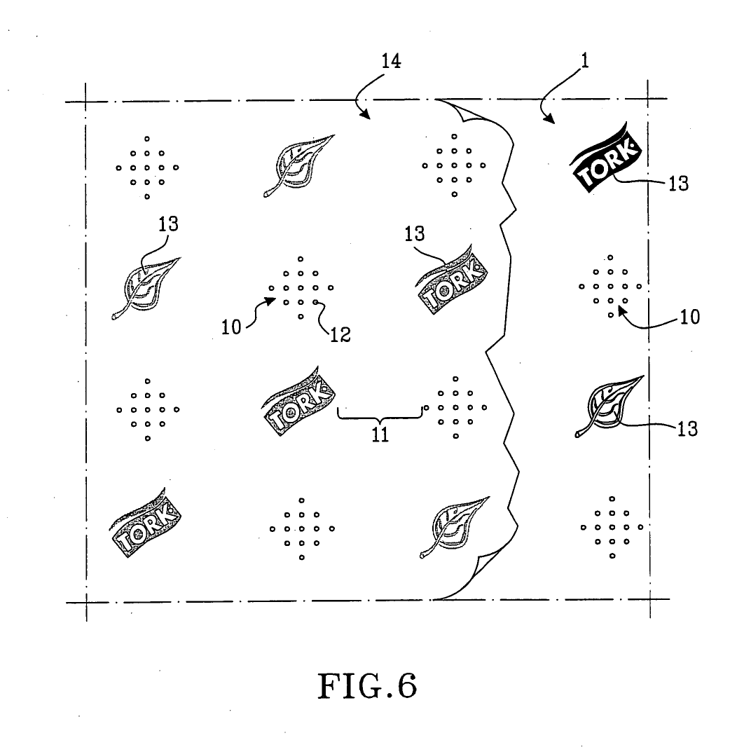

As stated above the three dimensional pattern of protuberances 8 on the central embossing roll 3 is interrupted by relatively smooth areas 9, which means that the paper web 1 (FIG. 6) will be embossed in selected areas 10 while leaving other areas 11 substantially non-embossed. The embossing pattern has an optional appearance and is characterized by a number of embossing sites 12 arranged in groups which are spaced from each other so as to leave smooth non-embossed areas 11 therebetween. A smooth non-embossed area 11 is defined as an uninterrupted area of at least 1 cm², preferably at least 1.5 cm² and more preferably at least 2 cm² having no embossment sites thereon. According to another embodiment the embossing pattern comprises individual embossing sites located spaced from each other, wherein the spaces between the individual embossing sites form said non-embossed areas.

The central embossing roll 3 and the printing roll 4 are synchronized so that said colorant is transferred at least mainly to the non-embossed areas 11 of the paper web in the selected printing pattern 13. The term “at least mainly” in this respect means that at least 50% of the printed area of said printing pattern 13 will be located on the non-embossed areas 1 of the paper web 1. According to preferred embodiments at least 75% and more preferably at least 90% of the printed area of the printing pattern 13 is located on the smooth non-embossed portions 11 of the paper web. According to one embodiment substantially all printed area of the printing pattern 13 is located on the relatively smooth non-embossed portions 11 of the paper web.

A second paper web 14 is via two guide rolls 15, 16 brought into a nip between a second embossing roll 17 and an impression roll 20. The impression roll can be of the type described above with respect to the impression roll 7. The paper web 1 can be a one-ply or a multi-ply material. The multi-ply web can be a laminated web in which the plies have been joined by for example gluing and/or embossing. The multi-ply web can alternatively comprise two or more plies which have not yet been joined.

The second embossing roll 17 has a three dimensional pattern of protuberances 18, said three dimensional pattern being interrupted by relatively smooth areas 19. The embossing pattern of the second embossing roll 17 is identical with or matches with the embossing pattern of the central first embossing roll 17. The term “matches with” in this respect means that the two embossing patterns may differ as to shape and/or size, but will overlap and match completely or to a substantial part when applied in a face-to-face relationship with each other.

The second paper web 14 after embossing enters a glue application station which comprises a glue chamber 21 from which glue is applied to a glue transfer roll 23 via a doctor roll 22. The glue transfer roll 23 is transferring glue to the areas of the second paper web 16 residing on the tops of the protuberances 18 of the second embossing roll 17. In a subsequent lamination step the second paper web 14 is laminated to the first paper web 1 by being passed through a nip between the central first embossing roll 3 and the second embossing roll 17. The two embossing rolls 3 and 17 are synchronized so that their respective protuberances will meet in a foot-to-foot relationship. The central first embossing roll 3 is used for keeping registry of the embossing, printing and lamination steps. The laminated web will as seen in cross section have the configuration as schematically shown in FIG. 2. The laminated web 24 is led via a guide roll 25 to optional subsequent conversion steps.

The printed pattern provided by the printing roll 4 will appear on the inside of the laminated multiply product 24, and will be visible through the plies 1, 14.

Preferred glues are the ones commonly used for paper, such as carboxy methyl cellulose (CMC), polyvinyl alcohol (PVOH), ethylene vinyl acetate (EVA), polyvinyl acetate (PVAc), ethylene acrylic acid, vinyl acetate acrylic acid, styrene acrylic acid, polyurethane, polyvinylidene chloride, starch, chemically modified starch, dextrin, water soluble polymers such as latexes and milky colloids in which natural or synthetic rubber or plastic is suspended in water. In case the material webs are of other material than paper glues suited for these materials are of course chosen.

Coloured glues may also be used, which gives a visual effect and therewith a patterning effect to the material.

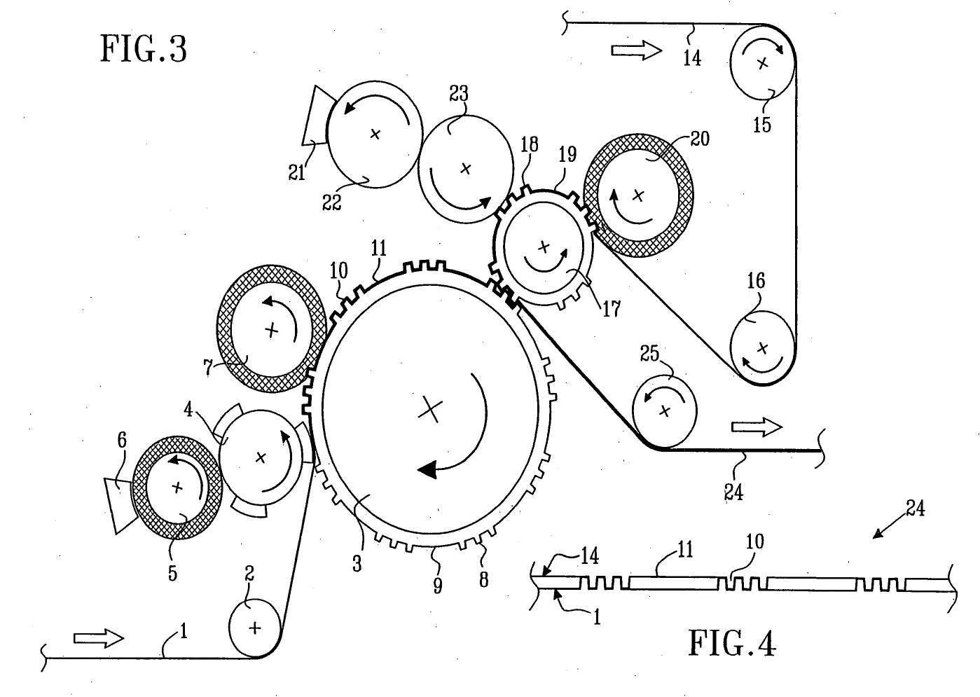

In the embodiment shown in FIGS. 3 and 4 the embossing rolls 3 and 17 are matching in a nested configuration, wherein the laminated web will have the appearance as illustrated in FIG. 4.

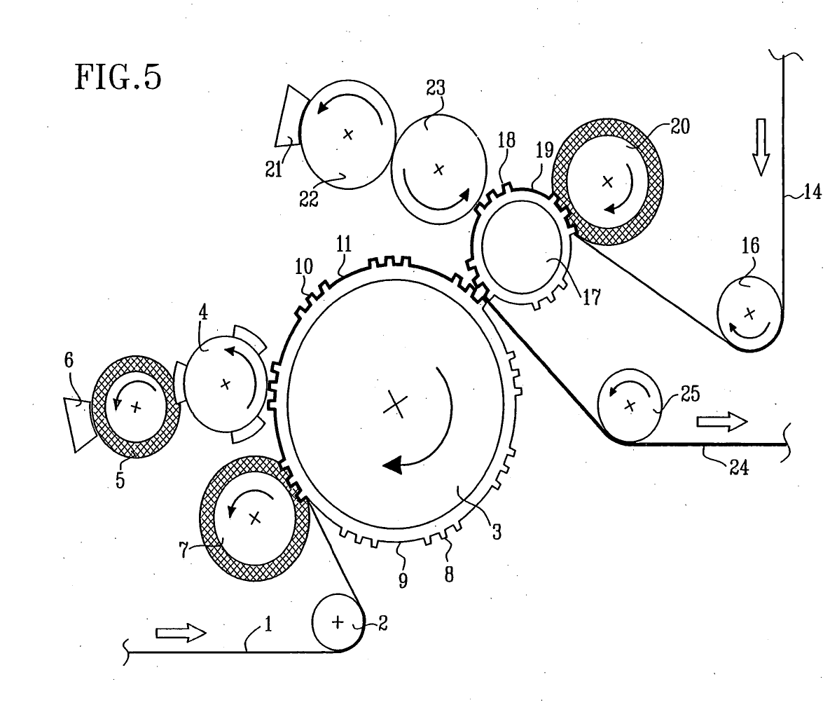

According to an alternative embodiment shown in FIG. 5 the embossing and printing steps of the first paper web 1 are reversed, so that embossing occurs before printing. Also in this case the central first embossing roll 3 and printing roll 4 are synchronized, so that the colorant is transferred at least mainly to the non-embossed areas 11 of the web in the selected pattern. This embodiment can have the advantage that the risk for smearing of the printed colorant is minimized, since the embossing takes place before printing.

The embossing and printing method and device according to the invention provides an improved printing quality since at least the main part of the printing pattern will be located on non-embossed areas of the web.

It is also encompassed by the present invention that one or both of the paper webs 1, 14 entering the embossing and printing stations has been given a first basic printed pattern, for example over its entire surface and that the pattern provided by the printing roll 4 is an additional pattern.

According to a further embodiment (not shown) the laminated web 20 is printed on its outside with a further printing pattern by a printing station arranged after the lamination station. Said further printing station is preferably kept in register with the first printing station by the central embossing roll 3.

It is further encompassed by the invention to only have a printing station after the lamination station, which printing station prints on the outside of the laminated web. Thus the printing station 4 which prints on the first paper web 1 may be eliminated. The printing station arranged after the lamination station is kept in register with the embossing and lamination stations against the central embossing roll 3.

In one embodiment a two-sided product may be obtained, in which the opposite sides of the product have different properties, for example one soft, smooth and absorbent side and one side for example having a more rough surface adapted for cleaning and/or a surface having a three-dimensional structure suited for wiping viscous fluids.

The paper webs 1 and 14 that are laminated can be either smooth but also have a three-dimensional structure provided earlier in the process, for example during forming, dewatering and/or drying of the paper web. A three-dimensional structure may also be provided by embossing the dry paper webs before lamination. The paper webs 1 and 14 laminated together may be of the same or different type. For example, as explained above, a two-sided product may be provided where different sides of the multiply product have different properties.

1. Method for producing a laminated embossed and printed web of flexible material, which comprises the following steps:
separately embossing each of two web-shaped materials in selected embossing patterns while leaving other areas substantially non-embossed;
printing at least one of said web-shaped materials in a selected printing pattern;
said printing and embossing steps being synchronized so that printing occurs mainly in the non-embossed areas of the web-shaped material;
transferring glue to the embossed areas of at least one of the web-shaped materials; and
adhesively joining the embossed areas of the two web-shaped materials in a lamination step to form a laminated web product.

2. Method as claimed in claim 1, wherein the two web-shaped materials are embossed with identical or matching embossing patterns, and the embossing and lamination steps are synchronized so that the embossed areas of the two web-shaped materials are joined in a foot-to-foot or nested configuration.

3. Method as claimed in claim 1, further comprising keeping registry of the embossing, printing and lamination steps by using a central embossing roll, which embosses one of said web-shaped materials, which cooperates with a printing roll for printing one of said web-shaped materials, and which cooperates with a second embossing roll embossing the other of said web-shaped materials, for laminating the two web-shaped materials together.

4. Method as claimed in claim 3, further comprising synchronizing the central embossing roll and the printing roll so that at least 50% of the printed area of said selected printing pattern will be located on the non-embossed areas of the web.

5. Method as claimed in claim 3, further comprising synchronizing the central embossing roll and the printing roll so that at least 75% and preferably at least 90% of the printed area of said selected printing pattern will be located on the non-embossed portions of the web.

6. Method as claimed in claim 3, further comprising synchronizing the central embossing roll and the printing roll so that substantially all printed area of said selected printing pattern will be located on the non-embossed portions of the web.

7. Method as claimed in claim 3, further comprising synchronizing the central embossing roll and the printing roll so as to arrange said selected embossed areas as groups of embossment sites, said groups being spaced apart and leaving substantially non-embossed areas between said groups of embossment sites, wherein at least some of said non-embossed areas have an uninterrupted surface area of at least 1 cm² having no embossment sites thereon.

8. Method as claimed in claim 3, further comprising synchronizing the central embossing roll and the printing roll so that at least some of said non-embossed areas will have an uninterrupted surface area of at least 1.5 cm² with no embossment sites thereon.

9. Method as claimed in claim 3, further comprising synchronizing the central embossing roll and the printing roll so that at least some of said non-embossed areas will have an uninterrupted surface area of at least 2 cm² with no embossment sites thereon.

10. A device for producing a laminated embossed and printed web of flexible material, which comprises:
a printing roll adapted to carry a colorant in a selected pattern;
a central first embossing roll having a three dimensional pattern of protuberances being interrupted by relatively smooth areas;
a second embossing roll having a three dimensional pattern of protuberances being interrupted by relatively smooth areas;
said printing roll and said second embossing roll cooperating with and kept in registry with said central first embossing roll.

11. The device as claimed in claim 10, wherein the three dimensional patterns of protuberances of the central first embossing roll and the second embossing roll are identical or matching, and said embossing rolls are kept in registry so that their respective protuberances will meet in a foot-to-foot or nested configuration.

12. A laminated, printed and embossed web of flexible material, comprising at least one web-shaped flexible material which is embossed in selected areas while other areas are non-embossed and the web-shaped flexible material is printed in a selected pattern in said non-embossed areas, wherein the at least one web-shaped flexible material is laminated with at least one further web-shaped flexible material which is embossed in selected areas while other areas are non-embossed, by adhesive joining of the embossed areas of the at least two web-shaped materials.

13. The laminated, printed and embossed web as claimed in claim 12, wherein the at least two web-shaped materials are embossed with identical or matching embossing patterns, and the embossed areas of the at least two web-shaped materials are joined in a foot-to-foot or nested configuration.

14. The laminated, printed and embossed web as claimed in claim 13, wherein at least 50% of the printed area of said selected printing pattern is located on the non-embossed areas of the web.

15. The printed and embossed web as claimed in claim 14, wherein at least 75% of the printed area of said selected printing pattern is located on the smooth, non-embossed portions of the web.

16. The printed and embossed web as claimed in claim 14, wherein at least 90% of the printed area of said selected printing pattern is located on the smooth, non-embossed portions of the web.

17. The printed and embossed web as claimed in claim 15, wherein substantially all printed area of said selected printing pattern is located on the smooth non-embossed portions of the web.

18. The printed and embossed web as claimed in claim 12, wherein said selected embossed areas are arranged as groups of embossment sites spaced apart so as to leave non-embossed areas between said groups of embossment sites, and at least some of said non-embossed areas have an uninterrupted surface area of at least 1 cm² having no embossment sites thereon.

19. The printed and embossed web as claimed in claim 18, wherein at least some of said non-embossed areas have an uninterrupted surface area of at least at least 1.5 cm² with no embossment sites thereon.

20. The laminated, printed and embossed web as claimed in claim 12, wherein the web is a tissue paper product.
